(19) United States
(12) Patent Application Publication
(10) Pub. No.: US 2025/0163217 A1
(43) Pub. Date: May 22, 2025

(54) Flame-retardant, partially aromatic polyamides

(71) Applicants: EMS-CHEMIE AG, Domat/Ems (CH); EMPA EIDGENÖSSISCHE MATERIALPRÜFUNGS- UND FORSCHUNGSANSTALT, Dubendorf (CH)

(72) Inventors: Christian SCHUBERT, Reinach (CH); Samuel Clark LIGON, Chur (CH); Botho HOFFMANN, Domat/Ems (CH); Sabyasachi GAAN, Gossau (CH); Nikita DRIGO, St. Gallen (CH); Muhammad Rashid NAZIR, Victoria, British Columbia (CA)

(21) Appl. No.: 18/687,212

(22) PCT Filed: Aug. 23, 2022
(86) PCT No.: PCT/EP2022/073369

§ 371 Date: Feb. 27, 2024

(30) Foreign Application Priority Data
Aug. 27, 2021 (CH) 0702132021

(51) Int. Cl. C08G 69/42; C08K 7/14; C08L 77/06

(52) U.S. Cl. CPC C08G 69/42; C08K 7/14; C08L 77/06; C08L 2201/02; C08L 2205/025

(57) ABSTRACT

The present invention pertains to inherently flame-resistant, partially aromatic polyamides comprising the polyamide units AB/AC/AE/DB/DC/DE/F, characterized in that, in addition to the polyamide units AC, at least one further polyamide unit is selected from the group consisting of the polyamide units AB, AE, DB, DC, DE and F, the monomer units A, B, C, D, E and F being derived from the following molecules which are present amidically bonded in the polyamide X:
A: aliphatic diamines;
B: aromatic phosphorus-free dicarboxylic acids;
C: phosphorus-containing, aromatic dicarboxylic acids according to formula 1, 2 and/or 3

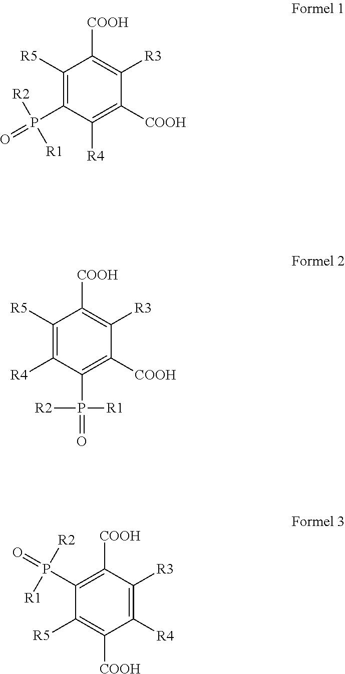

D: Diamines with aromatic structural units;
E: aliphatic dicarboxylic acids
F: aminocarboxylic acids, lactams.

The invention also pertains to flame-retardant molding compounds based on the flame-retardant polyamides and to molded parts formed from the polyamides or polyamide molding compounds according to the invention.

This invention relates to inherently flame-resistant, partially aromatic polyamides based on aliphatic diamines, aromatic dicarboxylic acids, partially containing phosphorus, and optionally other polyamide-forming components. The invention also relates to flame-retardant molding compounds based on inherently flame-resistant, partially aromatic polyamides. Polyamides as well as the molding compounds produced using them have good flame-retardant properties and show good mechanical properties. These molding compounds are especially suitable for the production of thin-walled molded parts for the electrical and electronics industry, such as housings, housing components or connectors. Furthermore, the invention relates to the use of the polyamides and polyamide molding compounds according to the invention for the production of molded parts, in particular components for the electrical and electronics industry and for the automotive industry.

Some applications have high requirements for plastics as far as their flame-retardant properties are concerned. The flame-retardant properties of plastics are absolutely essential for use in electrical or electronic devices especially due to the risk of short circuits.

In addition to plastics that are flame-retardant per se (=inherent flame protection) and plastics coated with a flame retardant, plastics with a reactive flame retardant are also used, i.e. the flame retardant is a component of the plastic and is chemically bound to it during polymerization. Compounding of flame-retardant additives is another variant for flame-retardant plastic fittings. Common additives are nitrogen-based compounds such as melamine and urea, brominated polystyrenes and organophosphorus compounds.

Another essential requirement for plastics is good mechanical properties, which can be further improved through fiber reinforcement, among other things. The latest technological advancements in the field of polyamides show several examples of glass fiber-reinforced, flame-retardant molding compounds. Achieving fire protection class UL 94 V0 is a particular challenge for glass fiber-reinforced polyamide molding compounds.

It is also important that the flame-retardant polyamides and polyamide molding compounds can be easily processed, e.g. in injection molding machines, melt spinning and extrusion systems, and in particular that no corrosion problems occur on the system parts due to the flame retardant.

EP 1 613 698 A1 refers to halogen-free, flame-retardant molding compounds based on partially aromatic, partially crystalline polyamides that contain salts of phosphinic acids as flame retardants. Due to their dimensional stability at high temperatures and their favorable fire behavior, these molding compounds are suitable for the production of thin-walled molded parts for the electrical and electronics industry. However, the particulate flame retardants used lead to a reduction in mechanical properties, particularly with regard to breaking stress, elongation at rupture, impact and notched impact properties, a deterioration in surface quality and corrosion of the system components that are used for production and processing.

CN 101 735 455 A describes a method for the production of aromatic polyoxadiazoles from terephthalic acid, hydrazine and modified isophthalic acid in a solvent and flame-resistant, high-temperature-resistant fibers that are wet-spun from it. The modified isophthalic acid has chlorine, bromine or diphenylphosphine oxide or diphenylphosphine sulfide substituents.

U.S. Pat. No. 4,837,394 refers to electrostatic toner particles based on a polyester resin which is a as a monomer and contains, among other things, a dimethyl isophthalic acid ester provided with a phosphonium substituent. The quaternary phosphonium groups act as charge carriers in the toner particles. Due to the homogeneous distribution of the charge carriers, even a very low content of quaternary phosphonium groups in the range of 10-9 to 10-4 mol/g is sufficient to realize an electrostatographic imaging process. However, this does not provide sufficient flame protection.

U.S. Pat. No. 3,108,991 discloses linear polyamides based on bis(aminoalkyl)alkylphosphines and aliphatic or aromatic dicarboxylic acids as well as aliphatic diamines and bis(carboxyalkyl)alkylphosphine oxides. The polyamides described dissolve in cold or warm water and have low softening temperatures.

U.S. Pat. No. 2,646,420 relates to oriented fibers based on linear condensation polymers that contain phosphorus in the polymer chain. In addition to good dyeing capability, the fibers also exhibit good mechanical properties, especially high initial strength and good resilience. In the examples, bis(carboxyphenyl)methylphosphine oxide is used as the phosphorus-containing monomer, which is condensed with various glycols or decanediamine.

The field of textile fibers is also covered by document U.S. Pat. No. 4,032,517 B, which comprises copolyamides containing 0.5 to 7.5% of phosphorus by weight as an integral part of the polymer chains. Bis(carboxyethyl)alkylphosphine oxides, which are polycondensed with hexanediamine and adipic acid, are recommended as phosphorus-containing dicarboxylic acids. The fibers should be permanently anti-static, moisture-regulating and flame-resistant.

WO 2018 071790 A1 discloses flame-retardant polyamides containing phosphorus in the polymer chain. The bis(4-methyoxy-carbonylphenoxy)phenylphosphine oxide used as the phosphorus-containing monomer is produced from methyl hydroxybenzoate and phenylphosphonic acid dichloride. The exchange reaction of this phosphorus-containing dicarboxylic acid with m-xylylenediamine (MXDA) is described. Such a polyamide with 5% of phosphorus-containing dicarboxylic acid by weight has an increased LOI value compared to MXD6 and achieves the classification V0 for 3.2-mm thick test specimens in the UL94 fire test.

JP11286545A describes phosphorus-containing copolyamides with a high glass transition temperature, which can be produced through polycondensation in an inert solvent at temperatures of 50 to 200° C. 2,5-dicarboxyphenyl phosphonic acid, 3,5-dicarboxyphenyl phosphinic acid and their derivatives are called phosphorus-carrying monomers. The copolyamides based on the specified dicarboxyphenyl phosphinic acids and the diamine 4,4′-oxydianiline and isophthalic acid as a further dicarboxylic acid have glass transition temperatures in the range from 240 to 276° C. Therefore, these polyamides cannot be polycondensed in the molten material.

The inherently flame-retardant polyamides that are described above in the latest technological advancements, and that contain phosphorus in the polymer chain have poor chemical resistance, are largely soluble even in cold or hot water, contain a “weak” C—P or C—O—P bond in the polymer chain and generally have low softening temperatures, in particular low glass transition temperatures and thus a rather low dimensional stability under heat.

### DESCRIPTION OF THE INVENTION

One of the tasks of this invention is to avoid these disadvantages known from the latest technological advancements and to provide inherently flame-retardant, partially aromatic polyamides and polyamide molding compounds produced therefrom such that they are characterized by good mechanical and thermal properties, good surface quality, high temperature resistance and good flame protection. The polyamides and polyamide molding compounds according to the invention should preferably have a fire protection classification V0 according to UL94 for test specimens with a thickness of 0.35 to 3.2 mm, in particular 0.5 mm.

According to this invention, this task is solved by a polyamide X with the polyamide units AB/AC/AE/DB/DC/DE/F according to claim 1, wherein, in addition to the polyamide units AC, at least one further polyamide unit is selected from the group consisting of the polyamide units AB, AE, DB, DC, DE and F, and wherein the monomer units A, B, C, D, E and F are derived from the following molecules which have amidic bonds in the polyamide X:
A: aliphatic diamines;
B: aromatic phosphorus-free dicarboxylic acids;
C: phosphorus-containing, aromatic dicarboxylic acids according to formula 1, 2 and/or 3

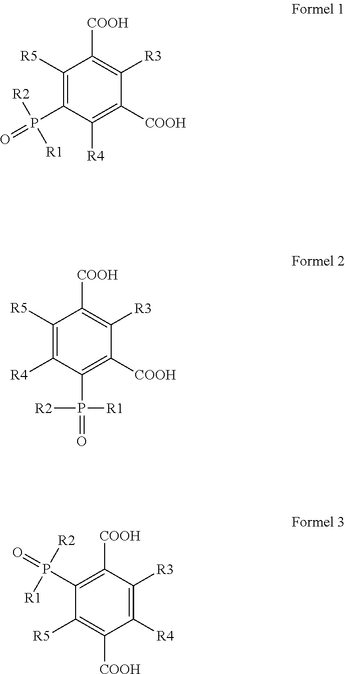

wherein each of the substituents R1, R2 are independently C1-C8-alkyl or aryl and each of the substituents R3, R4, R5 are independently H, alkyl, aryl, F, Cl, Br or P(R1)(R2)O;
D: Diamines with aromatic structural units;
E: aliphatic dicarboxylic acids
F: α,ω-aminocarboxylic acids, lactams.

This means that, in addition to the polyamide units AC, at least one more polyamide unit is present in the polyamide X according to the invention, i.e. at least two polyamide units must be present, for example in the combination of the units AB and AC or AC and F, and that the remaining polyamide units are therefore optional.

The aromatic dicarboxylic acids of component B are different from the dicarboxylic acids of component C; in particular, they are free of phosphorus.

The aforementioned polyamide units, e.g. the polyamide units AC or AB, are the repeating units in polyamide X. In the simplest case, the polyamide X is therefore a copolyamide that has at least two different repeating units, for example the polyamide units AC and AB. In this example, in addition to the aliphatic diamine A, two different aromatic dicarboxylic acids B and C are used in the production of polyamide X.

The task is also solved by a method for producing the polyamides according to the invention as mentioned in claim 9.

The task is further solved by providing a polyamide molding compound FM according to claim 10, comprising the polyamide X described above, and at least one filler and/or at least one additive and/or at least one polyamide Y that is different than polyamide X.

This task is further solved by the molded parts according to claim 13, which are at least partially formed using a polyamide X or the molding compound FM.

This task is finally solved by using the polyamides X according to the invention and by using the polyamide molding compounds FM according to claim 15 of the invention.

### Definitions of Terms

In accordance with this invention, the term “polyamide” (abbreviation PA) is understood to be a generic term which includes homopolyamides and copolyamides irrespective of their molar mass weight or viscosity. Thus, the generic term polyamide includes the polyamide pre-condensates having lower molecular weight as well as the homo- and copolyamides having higher molecular weight. The chosen notations and abbreviations for polyamides and their monomers correspond to those defined in ISO standard 16396-1 (2015 (D)). The abbreviations used therein are used in the following text as synonyms for the IUPAC names of the monomers; the following abbreviations for monomers are used in particular: T or TPS for terephthalic acid, I or IPS for isophthalic acid, MACM for bis(4-amino-3-methyl-cyclohexyl) methane (also known as 3,3′-dimethyl-4,4′-diaminodicyclohexylmethane, CAS no. 6864-37-5), PACM for bis(4-aminocyclohexyl) methane (also known as 4,4′-diaminodicyclohexylmethane, CAS no. 1761-71-3), TMDC for bis(4-amino-3,5-dimethylcyclohexyl) methane (also known as 3,3′,5,5′-tetramethyl-4,4′-diaminodicyclohexylmethane, CAS no. 65962-45-0). The abbreviation HMDA is used below for 1,6-hexanediamine (also known as hexamethylenediamine).

Compared to partially crystalline polyamides, amorphous polyamides exhibit no or only a very low, barely detectable fusion heat. In differential scanning calorimetry (DSC) according to ISO 11357 (2013), the amorphous polyamides preferably show fusion heat of less than 3 J/g and particularly preferably from 0 to 1 J/g at a heating rate of 20 K/min. Amorphous polyamides do not have a melting point due to their amorphous nature.

In addition to a glass transition temperature, partially crystalline polyamides have a pronounced melting point and, in differential scanning calorimetry (DSC) according to ISO 11357 (2013), they preferably show fusion heat of at least 15 J/g, preferably of at least 20 J/g, and particularly preferably in the range from 25 to 80 J/g at a heating rate of 20 K/min.

With regard to the polyamide X according to the invention, the monomers of the dicarboxylic acid and diamine components and any lactams/aminocarboxylic acids or mono-functional regulators used build the repeating units and/or end groups in the form of amides derived from the respective monomers as a result of the condensation. These normally make up at least 95 mol %, in particular at least 99 mol % of all repeating units and end groups present in the polyamide. In addition, the polyamide can also have small amounts of other repeating units, which can result from degradation or side reactions of the monomers, for example the diamines.

### Polyamide X

A polyamide according to this invention is a polyamide X with the polyamide units AB/AC/AE/DB/DC/DE/F, wherein, in addition to the polyamide units AC, at least one further polyamide unit selected from the group consisting of the polyamide units AB, AE, DB, DC, DE and F must be present. This means that the polyamide units that do not correspond to AC and the at least one other polyamide unit are optional and that polyamide X comprises only two polyamide units in the simplest case. The monomer units A, B, C, D, E and F are derived from the following bifunctional molecules, the monomers, which are amidically bonded in polyamide X.

Possible monomers for the production of polyamides X include components A, B, C, D, E and F:
A aliphatic diamines, preferably aliphatic diamines with 6 to 12 C atoms;
B aromatic phosphorus-free dicarboxylic acids, preferably isophthalic acid, terephthalic acid or a mixture thereof;
C phosphorus-containing, aromatic dicarboxylic acids according to formula 1, 2 and/or 3, wherein each of the substituents R1, R2 are independently C1-C8-alkyl or aryl and each of the substituents R3, R4, R5 are independently H, alkyl, aryl, F, Cl, Br or P(R1)(R2)O;
D diamines with aromatic structural unit;
E aliphatic dicarboxylic acids, preferably acyclic aliphatic dicarboxylic acids with 6 to 18 carbon atoms;
F α,ω-aminocarboxylic acids, lactams.

The preferred molar ratio of the total diamines and the total dicarboxylic acids used that are used and that are present in the polyamide X is 1.06:1 to 1:1.06, particularly preferably from 1.03:1 to 1:1.03 and especially preferably in a molar ratio of 1.01:1:1.01 in the polyamide X.

According to a preferred embodiment, the aliphatic diamine A is selected from the group consisting of 2-methyl-1,5-pentanediamine, hexanediamine, in particular 1,6-hexanediamine, 2,2,4-trimethyl-1,6-hexamethylenediamine, 2,4,4-trimethyl-1,6-hexamethylenediamine, nonanediamine, in particular 1,9-nonanediamine, 2-methyl-1,8-octanediamine, 1,10-decanediamine, 1,11-undecanediamine, 1,12-dodecanediamine, 1,3-diaminocyclohexane, 1,4-diaminocyclohexanediamine, isophorone diamine, 1,3-bis-(aminomethyl)cyclohexane (BAC), 1, 4-bis-(aminomethyl)cyclohexane, bis-(4-amino-3-methylcyclohexyl) methane (MACM), bis(4-aminocyclohexyl) methane (PACM), bis-(4-amino-3,5-dimethylcyclohexyl) methane (TMDC) and mixtures thereof. The aliphatic diamines A selected from the group consisting of diamines having 6 to 12 carbon atoms, in particular 1,6-hexanediamine, 2-methyl-1,8-octanediamine, 1,9-nonanediamine, 1,10-decanediamine, 1,3-bis(amino-methyl)cyclohexane and mixtures thereof are particularly preferred.

Aromatic phosphorus-free dicarboxylic acids that are preferably selected from the group consisting of terephthalic acid, isophthalic acid, 1,5-naphthalenedicarboxylic acid, 2,6-naphthalenedicarboxylic acid, 4,4′-diphenyldicarboxylic acid, 3,3′-diphenyldicarboxylic acid, 4,4′-diphenyl ether dicarboxylic acid, 4,4′-diphenylmethane dicarboxylic acid, 4,4′-diphenylsulfone dicarboxylic acid, 4,4′-diphenyl-isopropylidene dicarboxylic acid, 1,2-bis(phenoxy) ethane-4,4′-dicarboxylic acid, 2,5-anthracene-dicarboxylic acid, 4,4′-p-terphenylenedicarboxylic acid and 2,5-pyridinedicarboxylic acid are used as component B. The aromatic dicarboxylic acids B selected as terephthalic acid or a mixture of isophthalic acid and terephthalic acid are particularly preferred.

According to a further preferred embodiment, the phosphorus-containing aromatic dicarboxylic acids C are selected from the group consisting of 3,5-dicarboxyphenyldiphenylphosphine oxide, 3,5-dicarboxyphenyldimethylphosphine oxide, 3,5-dicarboxyphenyldiethylphosphine oxide, 2,4-dicarboxyphenyldiphenylphosphine oxide, 2,4-dicarboxyphenyldimethylphosphine oxide, 2,4-dicarboxyphenyldiethylphosphine oxide, in particular preferably selected as 3,5-dicarboxyphenyldiphenylphosphine oxide. 3,5-Dicarboxyphenyldiphenylphosphine oxide is a dicarboxylic acid according to formula 1, wherein the substituents R1 and R2 are phenyl and the substituents R3, R4 and R5 are hydrogen.

A further preferred embodiment of this invention provides that the diamines D are selected from the group consisting of m-xylylenediamine (MXDA), p-xylylenediamine (PXDA) and mixtures thereof. The diamine D selected as m-xylylenediamine is particularly preferred.

A further preferred embodiment of this invention provides that the aliphatic dicarboxylic acids E are selected from the group consisting of cyclohexane-1,3-dicarboxylic acid, cyclohexane-1,4-dicarboxylic acid, adipic acid, 1,7-heptanedioic acid, 1,8-octanedioic acid, 1,9-nonanedioic acid, 1,10-decanedioic acid, 1,11-undecanedioic acid, 1,12-dodecanedioic acid, 1,13-tridecanedioic acid, 1,14-tetradecanedioic acid, 1,15-pentadecanedioic acid, 1,16-hexadecanedioic acid, 1,17-heptadecanedioic acid, 1,18-octadecanedioic acid, and mixtures thereof. The aliphatic dicarboxylic acids E selected from the group consisting of dicarboxylic acids having 6 to 18 carbon atoms, in particular adipic acid, 1,10-decanedioic acid, 1,12-dodecanedioic acid, 1,14-tetradecanedioic acid, 1,16-hexadecanedioic acid, cyclohexane-1,3-dicarboxylic acid, cyclohexane-1,4-dicarboxylic acid and mixtures thereof are particularly preferred.

According to a further preferred embodiment of this invention, the α,ω-aminocarboxylic acids or the lactams F are selected from the group consisting of caprolactam, undecanolactam, lauric lactam, α,ω-aminocaproic acid, α,ω-aminoheptanoic acid, α,ω-aminoctanoic acid, α,ω-aminononanoic acid, α,ω-aminodecanoic acid, α,ω-aminoundecanoic acid (AUA) and α,ω-aminododecanoic acid (ADA), particularly preferred are α,ω-aminoundecanoic acid, caprolactam and laurinlactam as well as mixtures thereof.

Furthermore, the polyamides X can contain at least one mono-functional carboxylic acid G1 or mono-functional amine G2 polymerized as a mono-functional regulator G. The mono-functional regulators G are used for the final capping of the polyamides produced according to the invention. All monocarboxylic acids G1 which are capable of reacting with at least some of the available amino groups under the reaction conditions of polyamide condensation are suitable in principle. Suitable monocarboxylic acids G1 are aliphatic monocarboxylic acids, alicyclic monocarboxylic acids and aromatic monocarboxylic acids. These include formic acid, acetic acid, propionic acid, n-, iso- or tertiary butyric acid, valeric acid, trimethyl acetic acid, caproic acid, oenanthic acid, caprylic acid, pelargonic acid, capric acid, undecanoic acid, lauric acid, tridecanoic acid, myristic acid, palmitic acid, stearic acid, pivalic acid, cyclohexanecarboxylic acid, benzoic acid, methylbenzoic acids, α-naphthalenecarboxylic acid, β-naphthalenecarboxylic acid, phenylacetic acid, oleic acid, ricinoleic acid, linoleic acid, linolenic acid, erucic acid, acrylic acid, methacrylic acid and mixtures thereof. The monocarboxylic acid G1 selected from acetic acid, propionic acid, benzoic acid, stearic acid and mixtures thereof is particularly preferred. In a particular embodiment, the aliphatic polyamides (X) contain only benzoic acid polymerized as monocarboxylic acid G1.

The polyamides X may contain at least one polymerized monoamine G2. The monoamines G2 are used for the final capping of the polyamides produced according to the invention. All monoamines which are capable of reacting with at least some of the available carboxylic acid groups under the reaction conditions of polyamide condensation are suitable in principle. Aliphatic monoamines are preferred monoamines G2. These include methylamine, ethylamine, propylamine, butylamine, hexylamine, heptylamine, octylamine, decylamine, stearylamine, dimethylamine, diethylamine, dipropylamine, dibutylamine, cyclohexylamine, dicyclohexylamine and mixtures thereof.

A polyamide X, in which the content of the polyamide units AC is 1 to 99 mol %, preferably 10 to 90 mol %, in particular preferably 10 to 60 mol %, and the content of at least one further polyamide unit is 1 to 99 mol %, preferably 10 to 90 mol %, in particular preferably 40 to 90 mol %, in each case based on the sum of the polyamide units AC and the at least one further polyamide unit AB, AE, DB, DC, DE, F, is preferred.

A polyamide X, in which at least one of the following selection groups is selected with respect to components A to F, particularly preferably the selection groups for components A, B and C or A, B, C and E are selected and in particular preferably all selection groups are selected simultaneously, is further preferred:
A: the aliphatic diamines A selected from the group consisting of 1,6-hexanediamine, 2-methyl-1,8-octanediamine, 1,9-nonanediamine, 1,10-decanediamine, 1,12-dodecanediamine, 1,3-bis(amino-methyl)cyclohexane (BAC);
B: the aromatic phosphorus-free dicarboxylic acids are selected from the group consisting of terephthalic acid, isophthalic acid and mixtures thereof;
C: phosphorus-containing aromatic dicarboxylic acids C are selected from the group consisting of 3,5-dicarboxyphenyldiphenylphosphine oxide, 3,5-dicarboxyphenyldimethylphosphine oxide, 3,5-dicarboxyphenyldiethylphosphine oxide, 2,4-dicarboxyphenyldiphenylphosphine oxide, 2,4-dicarboxyphenyldimethylphosphine oxide, 2,4-dicarboxyphenyldiethylphosphine oxide, in particular preferably selected as 3,5-dicarboxyphenyldiphenylphosphine oxide, 3,5-dicarboxyphenyl-dimethylphosphine oxide or 3,5-dicarboxyphenyldiethylphosphine oxide;
D: the diamines with aromatic structural units are selected from the group consisting of m-xylylenediamine, p-xylylenediamine and mixtures thereof;
E: the aliphatic dicarboxylic acids are selected from the group consisting of adipic acid, 1,10-decanedioic acid, 1,12-dodecanedioic acid, 1,14-tetradecanedioic acid, 1,16-hexadecanedioic acid, cyclohexane-1,3-dicarboxylic acid, cyclohexane-1,4-dicarboxylic acid and mixtures thereof;
F: α,ω-aminocarboxylic acids or the lactams F are selected from the group consisting of α,ω-aminoundecanoic acid, caprolactam and lauric lactam as well as mixtures thereof.

In a preferred embodiment, the polyamide X is a polyamide, in which at least one further polyamide unit is selected from the group consisting of AB, AE and F, where the content of the polyamide unit AC is 1 to 99 mol %, preferably 10 to 90 mol %, in particular preferably 10 to 60 mol % and wherein the sum of the contents of the polyamide units AB, AE and F is 1 to 99 mol %, preferably 10 to 90 mol %, in particular preferably 40 to 90 mol %, in each case based on the sum of the polyamide units AB, AC, AE and F.

Another preferred polyamide is a polyamide X which comprises at least the polyamide units AB and AC and wherein the content of the polyamide unit AB is 1 to 99 mol %, preferably 10 to 90 mol %, more preferably 40 to 90 mol %, and wherein the content of the polyamide units AC is 1 to 99 mol %, preferably 10 to 90 mol %, more preferably 10 to 60 mol %, in each case based on the sum of the polyamide units AB and AC.

Another preferred polyamide is a polyamide X which comprises at least the polyamide units AB, AC and AE and wherein the content of the polyamide unit AC is 1 to 99 mol %, preferably 10 to 90 mol %, more preferably 10 to 60 mol %, and wherein the content of the polyamide units AB or AB and AE is 1 to 99 mol %, preferably 10 to 90 mol %, more preferably 40 to 90 mol %, in each case based on the sum of the polyamide units AB, AC and AE.

In a preferred embodiment, the polyamide X is a polyamide which comprises at least the polyamide units AB and AC and wherein the monomer units A, B and C are preferably derived from the following molecules which are amidically bonded in the polyamide X:
A: acyclic, aliphatic diamines selected from the group consisting of 1,6-hexanediamine, 1,10-decanediamine, 1,3-bis(amino-methyl)cyclohexane (BAC);
B: aromatic phosphorus-free dicarboxylic acids are selected from the group consisting of terephthalic acid, isophthalic acid and mixtures thereof;
C: phosphorus-containing aromatic dicarboxylic acids are selected from the group consisting of 3,5-dicarboxyphenyldiphenylphosphine oxide, 3,5-dicarboxyphenyldimethylphosphine oxide, 3,5-dicarboxyphenyldiethylphosphine oxide, 2,4-dicarboxyphenyldiphenylphosphine oxide, 2,4-dicarboxyphenyldimethylphosphine oxide, 2,4-dicarboxyphenyldiethylphosphine oxide.

A polyamide X, in which the aromatic dicarboxylic acids B are selected from the group consisting of terephthalic acid or a mixture of terephthalic acid and isophthalic acid, is also preferred.

Another preferred option is a polyamide X, in which the polyamide units AB are selected from the group consisting of the polyamide units 6I, 6T, 8I, 8T, 9I, 9T, 10I, 10T, 12I, 12T, 6T/6I, 9T/9I, 10T/10I, 12T/12I, 6T/10T, 6T/9T, 6T/8T, BACI, BACT, BACT/BACI, BACT/6T, BACT/10T, and/or the polyamide units AE are selected from the group consisting of the polyamide units 66, 610, 611, 612, 614, 616, 618, 106, 1010, 1011, 1012, 1014, 1016, 1018, BAC6, BAC10, BAC11, BAC12, BAC14, BAC16.

Another preferred option is a polyamide X, which comprises at least the polyamide units AB and AC and wherein the polyamide units AB consist of
(a1) 60 to 100 parts by weight, preferably 60 to 80 parts by weight, particularly preferably 67 parts by weight of polyamide units AB which are derived from terephthalic acid in combination with hexamethylenediamine, 1,3-bis(aminomethyl)cyclohexane and/or 1,10-decanediamine,
(a2) 0 to 40 parts by weight, preferably 20 to 40 parts by weight, particularly preferably 33 parts by weight of polyamide units AB which are derived from isophthalic acid in combination with hexamethylenediamine, 1,3-bis(aminomethyl)cyclohexane and/or 1,10-decanediamine,
   wherein the parts by weight of the components (a1) and (a2) together give 100 parts by weight, based on the polyamide units AB.

A polyamide X, which, in addition to components A to F, may also contain mono-functional regulators G as further components, is preferred among other things.

It is also preferable if the polyamide X consists exclusively of the polyamide units AC and AB and/or AE. In this case, the polyamide X is therefore the AB/AC, AC/AE or AB/AC/AE systems, which may also contain mono-functional regulators G as other components. The content of polyamide units AC is preferably 1 to 99 mol-%, particularly preferably 10 to 90 mol-% and especially preferably 10 to 60 mol-%, and the content of polyamide units AB and/or AE is preferably 1 to 99 mol-%, particularly preferably 10 to 90 mol-% and especially preferably 10 to 40 mol-%, in each case based on the sum of the polyamide units AB, AC and AE.

A polyamide X, which exclusively comprises the polyamide units AB and AC or exclusively the polyamide units AC and AE, is particularly preferred.

Another particularly preferred option is a polyamide X, which exclusively comprises the polyamide units AB and AC, and wherein the aliphatic diamines A are selected as 1,6-hexanediamine, 1,10-decanediamine and mixtures thereof, the aromatic dicarboxylic acids B are selected from terephthalic acid or a mixture of terephthalic acid and isophthalic acid, and the phosphorus-containing aromatic dicarboxylic acids C are selected from 3,5-dicarboxyphenyldiphenylphosphine oxide, 3,5-dicarboxyphenyl-dimethylphosphine oxide, 3,5-dicarboxyphenyldiethylphosphine oxide and mixtures thereof.

The polyamides X are preferably partially crystalline polyamides, which have an enthalpy of fusion of at least 15 J/g, particularly preferably of at least 20 J/g.

The polyamide X in the form of the pre-condensates preferably has a solution viscosity nrel that is determined using a solution of 0.5 g of polymer granules in 100 ml of m-cresol at 20° C. according to ISO 307:2007, in the range from 1.08 to 1.39, particularly preferably in the range from 1.10 to 1.35, especially in the range from 1.12 to 1.30.

The polyamide X with high molecular weight or post-condensed form preferably has a solution viscosity ηᵣₑₗ that is determined using a solution of 0.5 g of polymer granules in 100 ml of m-cresol at 20° C. according to ISO 307:2007, in the range from 1.40 to 2.50, preferably in the range from 1.45 to 2.20, especially in the range from 1.50 to 2.00.

The polyamides X preferably have a phosphorus content of at least 1.0% by weight, more preferably a phosphorus content in the range from 1.5 to 7% by weight and more preferably in the range from 1.7 to 4.0% by weight.

The polyamides according to the invention have good flame protection and preferably have a flame protection classification V0, determined according to UL94 (“Tests for Flammability of Plastic Materials for Parts in Devices and Applications” of the Underwriters Laboratories) on test specimens of the dimensions 127×12.7×0.35 mm, 127×12.7×0.5 mm, 127×12.7×0.75 mm, 127×12.7×1.5 mm and 127×12.7×3.0 mm, which were previously conditioned for 48 hours in a standard climate at 23° C. and a relative humidity of 50% or stored for 7 days at 70° C. in a convection oven.

The production of polyamide X preferably comprises a polycondensation reaction between at least one aromatic phosphorus-free dicarboxylic acid B and/or an aliphatic dicarboxylic acid E, at least one phosphorus-containing, aromatic dicarboxylic acid C according to formula 1, 2 and/or 3, wherein each of the substituents R1, R2 are independently C1-C8-alkyl or aryl and each of the substituents R3, R4, R5 are independently H, alkyl, aryl, F, Cl, Br or P(R1)(R2)O, and at least one aliphatic diamine A and, if necessary, further monomers D and F, optionally in the presence of mono-functional regulators G and/or auxiliary materials for processes.

Preferred auxiliary materials for processes are inorganic and organic stabilizers, catalysts and defoamers. Phosphorus compounds such as phosphoric acid, phosphorous acid, hypophosphorous acid, phenylphosphonic acid, phenylphosphinic acid and/or their salts with mono- to trivalent cations, such as Na, K, Mg, Ca, Zn or Al, and/or their esters, such as triphenylphosphate, triphenylphosphite or tris-(nonylphenyl)-phosphite are preferred catalysts. Hypophosphorous acids and their salts, such as sodium hypophosphite, are particularly preferred as catalysts.

Starting from the monomers A to F, the polyamide X can be polycondensed in a pressure vessel to the high molecular weight polymer with a preferred number-average molar mass (Mn) of greater than 3000 g/mol, particularly preferably in the range from 4000 to 20,000 g/mol, or to a so-called pre-condensate, which has a lower number-average molar mass (Mn), preferably below 3000 g/mol, particularly preferably in the range from 800 to 2500 g/mol. The pre-condensate can be converted in subsequent stages by solid phase and/or molten material post-condensation into a polymer with high molecular weight and with a preferred number-average molar mass (Mn) of greater than 3000 g/mol, particularly preferably greater than 4000 g/mol, especially in the range from 4000 to 20,000 g/mol.

The method for production of polyamide X, which comprises at least the polyamide units AC and at least one further polyamide unit AB, AE, DB, DC, DE or F, is preferably carried out in pressurized vessels, wherein, after mixing the components A, C and at least one further component B, D, E, F and, if necessary, mono-functional regulators G and auxiliary materials for processes and water, a pressure phase at 240° C. to 330° C. is executed with subsequent expansion at 240° C. to 320° C., with subsequent degasification at 240° C. to 320° C. and discharge of the polyamide in the strand form or in powder form, cooling, granulation of the strands and drying of the granules or powder.

Depending on their melting point or glass transition temperature, the pre-condensates can be post-condensed in the solid phase at temperatures in the range from 150 to 300° C. The post-condensation of the molten material preferably takes place at temperatures of 300 to 400° C. in an extruder. Preferably, mixtures of two or more different pre-condensates can also be converted into a polyamide with high molecular weight using post-condensation. A polyamide X pre-condensate according to the invention can also be post-condensed together with another pre-condensate which does not contain the polyamide units AC to form a polyamide X with high molecular weight.

In addition, the invention also covers the provision of a polyamide molding compound FM comprising the polyamide X, and at least one filler and/or at least one additive and/or at least one polyamide Y that is different than polyamide X.

Polyamide Y is preferably selected from the group consisting of: polyamide 6, polyamide 66, polyamide 610, polyamide 612, polyamide 614, polyamide 616, polyamide 1010, polyamide 1012, polyamide 1014, polyamide 1016, polyamide 11, polyamide 12, polyamide 6/12, polyamide 6I, polyamide 9T, polyamide 10T, polyamide 6T/6I, polyamide 6T/66, polyamide 6T/10T or mixtures thereof. Polyamides 6T/6I, 6T/66, 6T/10T and mixtures thereof are particularly preferred as polyamide Y.

In a preferred embodiment, the polyamide molding compound FM contains the following components or preferably consists of the following components:
25 to 99.99% by weight of polyamide X
0 to 70% by weight of at least one filler T;
0.01 to 50% by weight of at least one additive S other than X and T;
wherein the components S, T and X together make up 100% by weight.

In a particularly preferred embodiment of the invention, the polyamide molding compound FM contains the following components or preferably consists of the following components:
25 to 100% by weight of a polymer mixture P containing or preferably comprising
   20 to 80% by weight of polyamide X and
   20 to 80% by weight of polyamide Y that is different from polyamide X, preferably selected from the group consisting of: polyamide 6, polyamide 66, polyamide 610, polyamide 612, polyamide 614, polyamide 616, polyamide 1010, polyamide 1012, polyamide 1014, polyamide 1016, polyamide 11, polyamide 12, polyamide 6/12, polyamide 6I, polyamide 9T, polyamide 10T, polyamide 6T/6I, polyamide 6T/66, polyamide 6T/10T or mixtures thereof,
   wherein the sum of X and Y is 100% by weight of the polymer mixture P;
0 to 70% by weight of at least one filler T;
0 to 50% by weight of at least one additive S other than X, Y and T;
wherein the components P, S and T together make up 100% by weight.

The polymer mixture P comprising exclusively of components X and Y is particularly preferred.

Polyamide Y is a polyamide that is free of polyamide units AC and DC, i.e. it does not contain component C. Polyamide Y preferably contains at least one of the polyamide units AB, AE, DB, DE, F. In a preferred embodiment, polyamide Y contains only polyamide units AE and/or F, i.e. it is preferably an aliphatic polyamide. In this case, it is particularly preferred if polyamide Y is selected from the group consisting of: polyamide 6, polyamide 66, polyamide 610, polyamide 612, polyamide 614, polyamide 616, polyamide 1010, polyamide 1012, polyamide 1014, polyamide 1016, polyamide 11, polyamide 12, polyamide 6/12, polyamide 6I, polyamide 9T, polyamide 10T, polyamide 6T/6I, polyamide 6T/66, polyamide 6T/10T or mixtures thereof.

The polyamide molding compounds FM according to this invention contain the components X and S or X, T and S and/or P, or P and S or P, T and S or preferably exclusively consist of the components X and S or X, T and S or P or P and S or P, T and S, with the proviso that the components X, T, S or P, T, S add up to 100% by weight. The specified ranges of the quantities for the individual components X, T, S or P, T, S are to be understood in such a way that an arbitrary quantity can be selected for each of the individual components within the specified ranges, provided that the strict quantity requirement indicating that the sum of all components X, T, S or P, T, S is 100% by weight is met.

The phosphorus content of the polymer mixture is preferable in the range from 0.8 to 6.0% by weight, particularly preferably in the range from 1.2 to 4.5% by weight and especially preferably in the range from 1.5 to 3.5% by weight.

Component T is a filler whose weight percentage in the polyamide molding compound FM is 0 to 70%. The fillers can be present in fibrous as well as particulate form, individually or as a mixture. Component T can therefore contain fibrous fillers (reinforcing agents) or particulate fillers or even a mixture of reinforcing agents and particulate fillers.

According to a preferred embodiment of this invention, component T is present in the polyamide molding compound FM in an amount from 10 to 60% by weight, more preferably from 20 to 55% by weight and particularly preferably from 25 to 50% by weight, wherein these quantities refer to the sum of the components X, T, S or the sum of the components P, T, S or the total weight of the polyamide molding compound FM.

It is particularly preferred if component T consists exclusively of reinforcing agents selected from the group consisting of glass fibers, carbon fibers, boron fibers, aramid fibers, basalt fibers and mixtures thereof. According to a preferred embodiment of the polyamide molding compound according to the invention, component T is entirely formed from glass fibers.

The glass fibers used have a cross-sectional area that is either circular (or synonymously round) or non-circular (or synonymously flat), where in the latter case, the dimensional ratio of the primary cross-sectional axis to the secondary cross-sectional axis is at least 2, preferably in the range from 2 to 6.

The reinforcement with glass fibers can be made using short fibers (e.g. cut glass with a length of 2 to 50 mm) or continuous fibers (long glass or rovings). In a preferred embodiment, the glass fibers used according to the invention are short glass fibers with a diameter in the range from 6 to 20 μm and preferably from 9 to 12 μm. The glass fibers are in the form of cut glass with a length of 2 to 50 mm. E and/or S glass fibers are used in particular according to the invention. However, all other types of glass fibers, such as A, C, D, M, R glass fibers or any mixtures thereof or mixtures with E and/or S glass fibers can also be used. The usual sizings for polyamide, such as various aminosilane sizings, are used, whereby high-temperature stable sizings are preferred.

In the case of flat glass fibers, i.e. glass fibers with a non-circular cross-sectional area, those with a dimensional ratio of the primary cross-sectional axis to the secondary cross-sectional axis perpendicular to it, i.e. a ratio of at least 2, preferably 2.5 to 4.5, in particular 3 to 4, are preferred. These so-called flat glass fibers have an oval, elliptical, elliptical (so-called cocoon fiber), polygonal, rectangular or nearly rectangular cross-sectional area provided with constriction(s). Another characteristic feature of the flat glass fibers used is that the length of the primary cross-sectional axis is preferably in the range from 6 to 40 μm, in particular in the range from 15 to 30 μm, and the length of the secondary cross-sectional axis is in the range from 3 to 20 μm, in particular in the range from 4 to 10 μm.

Mixtures of glass fibers with circular and non-circular cross-sections can also be used to reinforce the molding compounds according to the invention, whereby the proportion of flat glass fibers preferably predominates, i.e. it is more than 50% by weight of the total mass of the fibers. The glass fibers can be provided with a sizing suitable for thermoplastics, in particular for polyamide, containing an adhesion promoter based on an amino or epoxysilane compound.

The flat glass fibers of component T are preferably selected as E-glass fibers according to ASTM D578-00 with a non-circular cross-section, preferably with a composition of 52 to 62% silicon dioxide, 12 to 16% aluminum oxide, 16 to 25% calcium oxide, 0 to 10% borax, 0 to 5% magnesium oxide, 0 to 2% alkali oxides, 0 to 1.5% titanium dioxide and 0 to 0.3% iron oxide. The glass fibers of component (T) are flat E-glass fibers and preferably have a density of 2.54 to 2.62 g/cm³, a tensile modulus of elasticity of 70 to 75 GPa, a tensile strength of 3000 to 3500 MPa and an elongation at break of 4.5 to 4.8%, whereby the mechanical properties were determined on single fibers with a diameter of 10 μm and a length of 12.7 mm at 23° C. and a relative humidity of 50%.

Component T may also contain other particulate fillers, if necessary, in surface-treated form, selected from the following group: kaolin, calcined kaolin, aluminum oxide, hydrated magnesium silicate, talc, mica, silicate, quartz, wollastonite, amorphous silicic acids, magnesium carbonate, magnesium hydroxide, chalk, lime, feldspar, solid or hollow glass beads or ground glass, in particular ground glass fibers and mixtures of the elements from this group. Micro glass beads with an average diameter in the range of 5 to 100 μm are particularly preferred as fillers, since these tend to give isotropic properties to the molded part and thus allow the production of molded parts with low warpage.

According to a preferred embodiment of this invention, component T exclusively consists of a glass filler selected from the group comprising glass fibers, ground glass fibers, glass particles, glass flakes, glass spheres, hollow glass spheres or combinations thereof. If glass spheres or glass particles are selected as component T, their average diameter is 0.3 to 100 μm, preferably 0.7 to 30 μm, particularly preferred 1 to 10 μm.

Another preferred embodiment of this invention intends that the glass types of component T is selected from the group consisting of E-glass, ECR-glass, S-glass, A-glass, AR-glass and R-glass, especially E- and S-glass, as well as mixtures of these glass types.

According to a preferred embodiment, component T is a high-strength glass fiber or so-called S-glass fiber. This is preferably based on the ternary system silicon dioxide-aluminum oxide-magnesium oxide or on the quaternary system silicon dioxide-aluminum oxide-magnesium oxide-calcium oxide, where the preferred composition is 58 to 70% by weight of silicon dioxide (SiO₂), 15 to 30% by weight of aluminum oxide (Al₂O₃), 5 to 15% by weight of magnesium oxide (MgO), 0 to 10% by weight of calcium oxide (CaO), 0 to 2% by weight of other oxides, such as zirconium dioxide (ZrO₂), boron oxide (B₂O₃), titanium dioxide (TiO₂), iron oxide (Fe₂O₃), sodium oxide, potassium oxide and lithium oxide (Li₂O).

It is especially preferred if the high-strength glass fiber has the following composition: 62 to 66% by weight of silicon dioxide (SiO₂), 22 to 27% by weight of aluminum oxide (Al₂O₃), 8 to 12% by weight of magnesium oxide (MgO), 0 to 5% by weight of calcium oxide (CaO), 0 to 1% by weight of other oxides, such as zirconium dioxide (ZrO₂), boron oxide (B₂O₃), titanium dioxide (TiO₂), iron oxide (Fe₂O₃), sodium oxide, potassium oxide and lithium oxide (Li₂O).

The high-strength glass fibers (S-glass fibers) feature preferably a tensile strength of at least 3700 MPa, preferably of at least 3800 or 4000 MPa, and/or an elongation at break of at least 4.8%, preferably of at least 4.9 or 5.0% and/or a tensile modulus of elasticity of more than 75 GPa, preferably more than 78 or 80 GPa, these glass properties being determined on single fibers (pristine single filaments) with a diameter of 10 μm and a length of 12.7 mm at a temperature of 23° C. and a relative humidity of 50%.

The polyamide molding compound FM according to the invention contains 0 to 50% by weight of at least one additive as component S, which is different from components X, T and Y.

According to a preferred embodiment, the polyamide molding compound FM pertaining to the invention contains 0.01 to 50% by weight or 0.01 to 30% by weight and particularly preferably 0.02 to 20% by weight of at least one additive as component S, these quantities referring to the sum of components X, T, S or the sum of components P, T, S or the total weight of the polyamide molding compound FM.

According to a preferred embodiment, component S is selected from the group consisting of lubricants, heat stabilizers, processing stabilizers, processing aids, viscosity modifiers, oxidation retarders, agents against heat decomposition and decomposition by ultraviolet light, UV blockers, anti-friction agents and mold release agents, colorants, especially dyes, inorganic pigments, organic pigments, plasticizers, flame retardants, impact strength modifiers and mixtures thereof.

In order to improve the flame-retardant properties, the polyamide molding compounds FM can also contain flame retardants as additives, whereby the flame-retardant additives are preferably halogen-free. Preferred flame-retardant additives are phosphinic acid salts and/or diphosphinic acid salts, which are preferably used together with a synergist, especially a nitrogen-containing synergist and/or a nitrogen and phosphorus-containing flame retardant, preferably melamine or condensation products of melamine, such as especially preferably selected from the group: Melem, Melam, Melon, solidified products of melamine with polyphosphoric acid, such as melamine polyphosphate, solidified products of condensation products of melamine with polyphosphoric acid or mixtures thereof. Among the phosphinic acid salts, the aluminum, calcium or zinc salts of alkyl or dialkylphosphinic acids, especially aluminum diethylphosphinate, are particularly preferred.

In a further embodiment, the synergist is preferably selected as an oxygen-, nitrogen- or sulfur-containing metal compound. Preferred metals include aluminum, calcium, magnesium, barium, sodium, potassium and zinc. Suitable compounds are selected from the group of oxides, hydroxides, carbonates, silicates, borates, phosphates, stannates, alkoxides, carboxylates and combinations or mixtures of these compounds, such as oxide-hydroxides or oxide-hydroxide-carbonates. Examples for this include magnesium oxide, calcium oxide, aluminum oxide, zinc oxide, barium carbonate, magnesium hydroxide, aluminum hydroxide, boehmite, pseudo-boehmite, dihydrotalcite, hydrocalumite, calcium hydroxide, calcium hydroxyapatite, tin oxide hydrate, zinc hydroxide, zinc borate, zinc sulfide, zinc phosphate, sodium carbonate, calcium carbonate, calcium phosphate, magnesium carbonate, basic zinc silicate, zinc stannate. It is also possible to use systems such as calcium stearate, zinc stearate, magnesium stearate, barium stearate, potassium palmitate, magnesium behenate.

Suitable phosphinic acids for the production of the phosphinic acid salts according to the invention are, for example, dimethylphosphinic acid, ethylmethylphosphinic acid, diethylphosphinic acid, methyl-n-propylphosphinic acid, methane-di(methylphosphinic acid), ethane-1,2-di(methylphosphinic acid), hexane-1,6-di(methylphosphinic acid), benzene-1,4-di(methylphosphinic acid), methylphenylphosphinic acid, diphenylphosphinic acid. The phosphinic acid salts can be produced, for example, by allowing the phosphinic acids to react in aqueous solution with metal carbonates, metal hydroxides or metal oxides, whereby essentially monomeric phosphinic acid salts are formed, and depending on the reaction conditions, possibly also polymeric phosphinic acid salts.

Preferably, the content of these halogen-free flame-retardant additives of component S is at most 10% by weight, particularly preferably at most 5% by weight, in each case based on the total molding compound FM, and particularly preferably the molding compound FM is free of flame-retardant additives S.

According to a particularly preferred embodiment, the polyamide molding compound FM contains at least one lubricant as component S, preferably in a proportion of 0 to 2% by weight, particularly preferably of 0.01 to 2.0% by weight, especially preferably of 0.01 to 1.5% by weight and most preferably of 0.02 to 1.0% by weight, in each case based on the total weight of the components X, T, S or P, T, S or the molding compound FM. Preferred options here include alkali salts, alkaline salts, alkaline earth salts, esters or amides of fatty acids with 10 to 44 C atoms and preferably with 14 to 44 C atoms, whereby the metal ions Na, Mg, Ca and Al are preferred and Ca or Mg are particularly preferred. Particularly preferred metal salts include Ca-stearate and Ca-montanate as well as Al-stearate. The fatty acids can be mono- or bivalent. Examples of this include pelargonic acid, palmitic acid, lauric acid, margaric acid, dodecanedioic acid, behenic acid and the particularly preferred stearic acid, capric acid and montanic acid (mixture of fatty acids with 30 to 40 C atoms).

Aliphatic alcohols, which can be monohydric to tetrahydric, are also preferred as lubricants. These alcohols are preferably selected from the group consisting of n-butanol, n-octanol, stearyl alcohol, ethylene glycol, propylene glycol, neopentyl glycol, glycerol, pentaerythritol and mixtures thereof, glycerol and pentaerythritol being preferred.

In addition, aliphatic amines, which may be mono- to trivalent, are preferred lubricants. Preferred amines are selected from the group consisting of stearylamine, ethylenediamine, propylenediamine, hexamethylenediamine, di(6-aminohexyl)amine and mixtures thereof, with ethylenediamine and hexamethylenediamine being particularly preferred.

Preferred esters or amides of fatty acids are selected from the group consisting of glycerol distearate, glycerol tristearate, ethylenediamine distearate, glycerol monopalmitate, glycerol trilaurate, glycerol monobehenate, pentaerythritol tetrastearate and mixtures thereof. Furthermore, white oils or silicone oils can also be used alternatively or additionally.

According to a further preferred embodiment, the polyamide molding compound FM contains at least one heat stabilizer as component S, this preferably being present in a proportion of 0 to 3% by weight, especially preferably 0.02 to 2.0% by weight, in each case based on the total weight of the components X, T, S or P, T, S or the molding compound FM.

According to a preferred embodiment, the heat stabilizers are selected from the group consisting of
compounds of monovalent or divalent copper, for example salts of monovalent or divalent copper with inorganic or organic acids or monovalent or divalent phenols, the oxides of monovalent or divalent copper, or the complex compounds of copper salts with ammonia, amines, amides, lactams, cyanides or phosphines, preferably Cu(I) or Cu(II) salts of hydrohalic acids, hydrocyanic acids or the copper salts of aliphatic carboxylic acids. Particularly preferred compounds include the monovalent copper compounds CuCl, CuBr, CuI, CuCN and Cu₂O, as well as the divalent copper compounds CuCl₂, CuSO₄, CuO, copper (II) acetate or copper (II) stearate. Advantageously, the copper compounds are used in combination with other metal halides, especially alkali metal halides, such as Nal, KI, NaBr, KBr, or ammonium halides, the molar ratio of metal halide to copper halide being 0.5 to 20, preferably 1 to 10 and particularly preferably 3 to 7.
Lanthanide compounds selected from the group consisting of acetates, fluorides, chlorides, bromides, iodides, oxide halides, sulfates, nitrates, phosphates, chromates, perchlorates, oxalates, the monochalcogenides of sulfur, selenium and tellurium, carbonates, hydroxides, oxides, trifluoromethanesulfonates, acetylacetonates, alcoholates, 2-ethylhexanoates of the lanthanides lanthanum, cerium, praeseodymium, neodymium, promethium, samarium, europium, gadolinium, terbium, dysprosium, holmium, erbium, thulium, ytterbium and lutetium and—hydrates of the above-mentioned salts and—mixtures of the above-mentioned compounds. Cerium or lanthanum compounds are particularly preferred, and the use of lanthanum (III) hydroxide, lanthanum (III) oxide hydroxide and cerium tetrahydroxide is particularly preferred here. Furthermore, it is preferred that the cation of the lanthanide compounds has an oxidation number of +III or +IV. The lanthanide compounds are preferably used in combination with alkali metal halides, alkaline earth metal halides and/or the above-mentioned copper compounds.
Stabilizers that are based on secondary aromatic amines, whereby these stabilizers are preferably present in an amount of 0.2 to 2, preferably 0.2 to 1.5% by weight,
stabilizers that are based on sterically hindered phenols, whereby these stabilizers are preferably present in an amount of 0.1 to 1.5, preferably 0.2 to 1.0% by weight, and
phosphites and phosphonites, as well as
mixtures of the above-mentioned stabilizers.

Particularly preferred examples of stabilizers based on secondary aromatic amines which can be used according to the invention are adducts of phenylenediamine with acetone (Naugard A), adducts of phenylenediamine with linolenes, Naugard 445, N,N′-dinaphthyl-p-phenylenediamine, N-phenyl-N′-cyclohexyl-p-phenylenediamine or mixtures of two or more of these.

In principle, all compounds with a phenolic structure which have at least one sterically demanding group on the phenolic ring are suitable as sterically hindered phenols. Preferred examples of stabilizers based on sterically hindered phenols which can be used according to the invention are N,N′-hexamethylene-bis-3-(3,5-di-tert-butyl-4-hydroxyphenyl)-propionamide, bis-(3,3-bis-(4′-hydroxy-3′-tert-butylphenyl)-butanoic acid)-glycol ester, 2,1′-thioethylbis-(3-(3,5-di. tert-butyl-4-hydroxyphenyl)-propionate, 4-4′-butylidene-bis-(3-methyl-6-tert. butylphenol), triethylene glycol 3-(3-tert-butyl-4-hydroxy-5-methylphenyl) propionate or mixtures of two or more of these stabilizers.

Preferred phosphites and phosphonites are triphenylphosphite, diphenylalkylphosphite, phenyldialkylphosphite, tris(nonylphenyl) phosphite, trilaurylphosphite, trioctadecylphosphite, distearylphentaerythritol diphosphite, tris(2,4-di-tert-butylphenyl) phosphite, diisodecylpentaerythritol diphosphite, bis(2,4-di-tert-butylphenyl) pentaerythritol diphosphite, bis(2,6-di-tert-butyl-4-methylphenyl)-pentaerythritol diphosphite, diisodecyloxypentaerythritol diphosphite, bis(2,4-di-tert-butyl-6-methylphenyl) pentaerythritol diphosphite, bis(2,4,6-tris-(tert-butylphenyl)) pentaerythritol diphosphite, tristearylsorbitol triphosphite, tetrakis(2,4-di-tert-butylphenyl)-4,4′-biphenylenediphosphonite, 6-isooctyloxy-2,4,8,10-tetra-tert-butyl-12H-dibenz-[d,g]-1,3,2-dioxaphosphocin, 6-fluoro-2,4,8,10-tetra-tert-butyl-12-methyl-dibenz [d,g]-1,3,2-dioxaphosphocin, bis(2,4-di-tert-butyl-6-methylphenyl)methylphosphite and bis(2,4-di-tert-butyl-6-methylphenyl)ethylphosphite. Especially, tris [2-tert-butyl-4-thio(2′-methyl-4′-hydroxy-5′-tert-butyl)-phenyl-5-methyl]phenylphosphite and tris(2,4-di-tert-butylphenyl)phosphite (Irgafos 168) are preferred.

A preferred embodiment of the heat stabilizer consists of a combination of organic heat stabilizers (especially Irgafos 168 and Irganox 1010), a bisphenol A based epoxide (especially Epikote 1001) and a copper stabilizer based on CuI and KI. A commercially available stabilizer mixture consisting of organic stabilizers and epoxides is, for example, Irgatec NC66 or Recylobyk 4371. Heat stabilization based exclusively on CuI and KI is particularly preferred.

Examples of oxidation retarders and heat stabilizers include phosphites and other amines (e.g. TAD), hydroquinones, various substituted representatives of these groups and mixtures thereof in concentrations of up to 1% by weight, based on the total weight of the components X, T, S or P, T, S or the molding compound FM.

Various substituted resorcinols, salicylates, benzotriazoles and benzophenones are mentioned as UV stabilizers, which are generally used in quantities of up to 2% by weight, based on the weight of the polyamide molding compound FM.

Inorganic pigments such as titanium dioxide, barium sulfate, zinc oxide, ultramarine blue, iron oxide and carbon black and/or graphite, as well as organic pigments such as phthalocyanines, quinacridones, perylenes and dyes such as nigrosine and anthraquinones can be added as colorants.

Component S may also comprise impact strength modifiers, preferably selected from the group consisting of polyolefins, polyolefin copolymers, styrene copolymers, styrene block copolymers, ionic ethylene copolymers, which may be partially neutralized by metal ions, and mixtures thereof. Preferably, the impact strength modifiers are functionalized. Preferably, the polyamide molding compounds FM contain 0 to 35% by weight, particularly preferably 5 to 20% by weight of impact strength modifiers.

According to a preferred embodiment of the present invention, the impact strength modifiers of component S are functionalized by copolymerization and/or by grafting. For this purpose, a compound selected from the group consisting of unsaturated carboxylic acids, unsaturated carboxylic acid derivatives and mixtures thereof and/or unsaturated glycidyl compounds is particularly preferably used. This is particularly preferably selected from the group consisting of unsaturated carboxylic acid esters, especially acrylic acid esters and/or methacrylic acid esters, unsaturated carboxylic acid anhydrides, especially maleic anhydride, glycidyl acrylic acid, glycidyl methacrylic acid, α-ethyl acrylic acid, maleic acid, fumaric acid, itaconic acid, citraconic acid, aconitic acid, tetrahydrophthalic acid, butenyl succinic acid and mixtures thereof.

If the functionalization of the impact strength modifiers is carried out by copolymerization, the proportion by weight of each individual compound used for functionalization is preferably in the range from 3 to 25% by weight, particularly preferably from 4 to 20% by weight and especially preferably from 4.5 to 15% by weight, in each case based on the total weight of the functionalized impact strength modifiers S.

If the impact strength modifiers are functionalized by grafting, the proportion by weight of each individual compound used for functionalization is preferably in the range from 0.3 to 2.5% by weight, particularly preferably from 0.4 to 2.0% by weight and particularly preferably from 0.5 to 1.9% by weight-, in each case based on the total weight of the functionalized impact strength modifiers S.

The impact strength modifiers preferably selected are polyolefins or polyolefin copolymers from the group consisting of polyethylene, polypropylene, polybutylene, ethylene-α-olefin copolymers, propylene-α-olefin copolymers, ethylene-propylene copolymers, ethylene-propylene-diene copolymers and mixtures thereof, wherein the α-olefins preferably have 3 to 18 carbon atoms. The α-olefins are particularly preferably selected from the group consisting of propene, 1-butene, 1-pentene, 1-hexene, 1-octene, 1-decene, 1-dodecene and mixtures thereof. Among the ethylene-α-olefin copolymers, ethylene-propylene copolymers, ethylene-1-butene copolymers or ethylene-propylene-1-butene copolymers are preferred.

The styrene copolymers are preferably styrene copolymers with a co-monomer selected from the group consisting of butadiene, isoprene, acrylate and mixtures thereof. The styrene block copolymers are preferably selected from the group consisting of styrene-butadiene-styrene triblock copolymers (SBS), styrene-isoprene-styrene triblock copolymers (SIS), styrene-ethylene/butylene-styrene triblock copolymers (SEBS), styrene-ethylene/popylene-styrene triblock copolymers (SEPS) and mixtures thereof.

The styrene-ethylene/butylene-styrene triblock copolymers are linear triblock copolymers consisting of one ethylene/butylene block and two styrene blocks. The styrene-ethylene/propylene-styrene triblock copolymers are linear triblock copolymers consisting of one ethylene/propylene block and two styrene blocks.

The styrene content in the styrene-ethylene/butylene-styrene triblock copolymers or styrene-ethylene/popylene-styrene triblock copolymers is preferably from 20 to 45% by weight, more preferably from 25 to 40% by weight and most preferably from 25 to 35% by weight.

The ionic ethylene copolymers preferably consist of the monomers selected from the group consisting of ethylene, propylene, butylene, acrylic acid, acrylate, methacrylic acid, methacrylate and mixtures thereof, wherein the acid groups are partially neutralized with metal ions, particularly preferred ones include ethylene-methacrylic acid copolymers or ethylene-methacrylic acid-acrylate copolymers in which the acid groups are partially neutralized with metal ions. The metal ions used for neutralization are preferably sodium, zinc, potassium, lithium, magnesium ions and mixtures thereof, particularly preferred are sodium, zinc and magnesium ions.

Furthermore, the present invention comprises molded parts produced from the polyamides X or the polyamide molding compound FM according to the invention or comprising at least one region or coating of a polyamide X or of a polyamide molding compound FM, preferably produced by injection molding, injection blow molding, injection compression molding, pultrusion, melt spinning, extrusion or blow molding.

Preferably, these molded parts are selected from the group consisting of fibers, films, profiles, tubes, containers, semi-finished products, finished parts or hollow parts, housings, housing parts, frames, protective housings, covers or cladding elements, especially for electrical appliances, electronic appliances, electro-optical appliances, electro-optical components, connectors, fans, especially fan wheels, office automation devices, consumer electronics, components for the automotive sector, especially selected from cylinder head covers, engine covers, housings for intercoolers, intercooler flaps, suction pipes, suction manifolds, connectors, gear wheels, fan wheels, intercoolers, headlamp housings, reflectors, adaptive headlight adjustment, gear wheels, plug connections, connectors, including those for gasoline, diesel, urea and compressed air lines, components for electric vehicles, profiles, foils or layers of multilayer foils, electronic components, housings for electronic components, tools, nozzles and fittings for connecting hoses or tubes, electrical or electronic component, a circuit board, a part of a circuit board, a housing component, a film, a line, especially in the form of a switch, a distributor, a relay, a resistor, a capacitor, a coil, a lamp, a diode, a LED, a transistor, a connector, a regulator, a memory and/or a sensor.

Finally, the invention also comprises the use of a polyamide X according to any one of claims 1 to 8, or a polyamide molding compound FM according to any one of claims 10 to 12, for the production of the previously described molded parts, especially in the form of fibers, films, profiles, tubes, containers, semi-finished products, finished parts or hollow parts, and for coating molded parts.

### WAYS OF CARRYING OUT THE INVENTION

### Measuring Methods:

Relative Viscosity (Solution Viscosity ηᵣₑₗ)

The relative viscosity was determined according to ISO 307 (2007) at 20° C. For this purpose, 0.5 g of polymer granules were dissolved in 100 ml of m-cresol; the calculation of the relative viscosity (RV) according to RV=t/t₀ was based on section 11 of the standard.

### Melting Point Tm and Enthalpy of Fusion ΔHm

The melting point and enthalpy of fusion were determined on the granulate in accordance with ISO 11357-3 (2013). The DSC (Differential Scanning calorimetry) measurements were carried out at a heating rate of 20 K/min.

### Glass Transition Temperature Tg

The glass transition temperature Tg was determined on granules using differential scanning calorimetry (DSC) in accordance with ISO 11357-2 (2013). After the second heating, the specimen was quenched in dry ice. The glass transition temperature (Tg) was determined during the third heating, which was carried out at a heating rate of 20 K/min. The center of the glass transition region, which was specified as the glass transition temperature, was determined using the “half height” method.

### End Groups (Amino and Carboxy End Groups)

The amino (NH₂) and acid (COOH) end group concentrations are determined by means of potentiometric titration. For the amino end groups, 0.2 to 1.0 g polyamide is dissolved in a mixture of 50 ml m-cresol and 25 ml isopropanol at 50 to 90° C. and titrated with a 0.05 molar perchloric acid solution after addition of aminocaproic acid. In order to determine the COOH end groups, 0.2 to 1.0 g of the specimen to be determined is dissolved in benzyl alcohol or a mixture of o-cresol and benzyl alcohol at 100° C., depending on solubility, and titrated with a 0.1 molar tetra-n-butylammonium hydroxide solution after addition of benzoic acid.

### Number-Average and Weight-Average Molar Masses (Mn, Mw)

The number-average and weight-average molar masses of polyamides were determined by gel permeation chromatography (GPC) with universal poly(methyl methacrylate) calibration. GPC analyses were performed by dissolving 2-4 mg of polyamide granules in 1 ml of hexafluoroisopropanol (HFIP) and passing the solution through an Agilent 1260 Infinity II high temperature GPC system equipped with a triple detector (refractive index detector, viscometer and light scattering detector). The measurements were carried out using a PL HFIP gel (9 μm particle size) two-column system under the following measurement conditions: Column temperature 40° C., HFIP with 20 mmol sodium trifluoroacetate as solvent, flow rate 1 ml/min, injection volume 100 μl.

### Production of the Test Specimens and UL 94 Test (Flame Protection Classification)

The flammability was tested by vertical burn tests according to UL-94 VB in accordance with IEC 60695-11-10 on test specimens measuring 127×12.7×0.5 mm. The test specimens were produced using the compression molding process (Lindenberg heating press, 320-330° C.). The test specimens were conditioned for 48 h in a standard climate at 23° C. and a relative humidity of 50% before the burn tests.

### EXAMPLES

The polyamides PA-1-NK, PA-2-NK, PA-3-NK and PA-4-NK were polycondensed in two stages. First, the low molecular weight pre-condensates (VK) were produced from diamine and dicarboxylic acids in the presence of water, which were then converted into the high molecular weight polyamides (NK) by solid phase and molten material post-condensation, either alone or in a mixture with another pre-condensate.

### Examples PA-1-VK to PA-4-VK

The diamines (component A) and dicarboxylic acids (components B, C, E) were charged into a 200 ml autoclave together with 15% by weight of water, based on the total batch, with the individual quantities being selected according to the composition given in Table 1 so that the total batch yielded approximately 100 g. The batch was heated to a temperature of 260° C. and then kept at this temperature for 2.5 hours during the pressure phase. The low-molecular polycondensate formed was then removed from the autoclave with steam via an opening. The pre-condensate was dried for 24 hours at 110° C. and a vacuum of 30 mbar before being subjected to post-condensation.

### Examples PA-1-NK to PA-4-NK

In the examples PA-1-NK, PA-2-NK and PA-3-NK, the respective pre-condensate alone (PA-1-VK, PA-2-VK, PA-3-VK) and in the example PA-4-NK, a mixture of two polyamide pre-condensates (PA-4-VK and PA-5-VK in a weight ratio of 1:1) was post-condensed in two stages as described below.

In a first stage, the pre-condensates were post-condensed in the solid phase over a period of 24 to 120 hours in a Binder VDL53 vacuum furnace at 200° C. and 30 mbar, before being further polycondensed in a microcompounder (Xplore MC 15HT) at 300 to 330° C. in a second stage. The microextruder is equipped with two valves and a heated channel through which material can be fed back into the upper end of the microextruder. Despite the short screw length, residence times of several minutes can be achieved thanks to this closed-loop operation. The average residence time in the examples was 5 minutes, the screw speed was 50 rpm, the screw torque was 40 Nm, the temperature of the cylinder was 330° C. and the temperature of the extruded molten material was 322° C. The polyamides were emptied into a metal tank and cooled to ambient temperature in an air atmosphere. The polymer specimen was then granulated (Hellweg M50/80) and the granulate dried for 24 hours at 110° C. under reduced pressure (30 mbar).

TABLE 1
Composition and properties of the pre- and post-condensates

| Pre-condensates | Unit | PA-1-VK | PA-2-VK | PA-3-VK | PA-4-VK | PA-5-VK |
|---|---|---|---|---|---|---|
| Component | | | | | | |
| 1,6-Hexanediamine (component A) | mol-% | 100 | 100 | 100 | 100 | 100 |
| Terephthalic acid (component B) | mol-% | 30 | 60 | 60 | 0 | 55 |
| 3,5- | mol-% | 30 | 40 | 20 | 60 | 0 |
| Dicarboxyphenyldiphenylphosphine | | | | | | |
| oxide (component C) | | | | | | |
| Adipic acid (component E) | mol-% | 40 | 0 | 20 | 40 | 45 |
| Properties | | | | | | |
| Relative viscosity (ηᵣₑₗ) | — | 1.18 | 1.20 | 1.29 | 1.17 | 1.19 |
| Amine end groups (NH₂) | μeq./g | 530 | 330 | 440 | 300 | 880 |
| Acid end groups (COOH) | μeq./g | 240 | 370 | 150 | 350 | 850 |

| Post-condensates | | PA-1-NK | PA-2-NK | PA-3-NK | PA-4-NK |
|---|---|---|---|---|---|
| Reactants for post-condensation | | PA-1-VK | PA-2-VK | PA-3-VK | PA-4-VK + |
| (weight ratio) | | (100%) | (100%) | (100%) | PA-5-VK |
| | | | | | (1:1) |
| Relative viscosity (ηᵣₑₗ) | — | 1.66 | 1.78 | 1.58 | 1.85 |
| Glass transition temperature** | ° C. | 108 | 175 | 130 | 95 |
| Melting point* | ° C. | — | — | 285 | 300 |
| Fusion heat ΔHₘ* | J/g | — | — | 15 | 25 |
| Numerical average molar mass Mn | g/mol | 7840 | 6700 | 8450 | 13700 |
| Weight average molar mass Mw | g/mol | 22500 | 21600 | 24300 | 37700 |
| Polydispersity (Mw/Mn) | — | 2.9 | 3.2 | 2.9 | 2.8 |
| Phosphorus content | Weight -% | 3.1 | 3.8 | 2.2 | 2.6 |
| Fire classification UL94 | — | V0 | V0 | V0 | V0 |
| Specimen thickness: 0.5 mm | | | | | |
| Conditioning: 48 h, 23° C., 50% r.h. | | | | | |

*Values of the 2nd heating,
**values of the 3rd heating

1. Polyamide X comprises the polyamide units AB/AC/AE/DB/DC/DE/F, characterized in that, in addition to the polyamide units AC, at least one further polyamide unit is selected from the group consisting of the polyamide units AB, AE, DB, DC, DE and F, the monomer units A, B, C, D, E and F being derived from the following molecules which are present amidically bonded in the polyamide X:
A: aliphatic diamines;
B: aromatic phosphorus-free dicarboxylic acids;
C phosphorus-containing, aromatic dicarboxylic acids according to formula 1, 2 and/or 3
wherein each of the substituents R1, R2 are independently C1-C8-alkyl or aryl and each of the substituents R3, R4, R5 are independently H, alkyl, aryl, F, Cl, Br or P(R1)(R2)O;
D: Diamines with aromatic structural units;
E: aliphatic dicarboxylic acids
F: α,ω-aminocarboxylic acids, lactams.

2. Polyamide according to claim 1, characterized in that
the content of the polyamide units AC is 1 to 99 mol %, preferably 10 to 90 mol %, more preferably 10 to 60 mol %,
and the content of the at least one further polyamide unit is 1 to 99 mol %, preferably 10 to 90 mol %, more preferably 40 to 90 mol %, in each case based on the sum of the polyamide units AC and the at least one further polyamide unit.

3. Polyamide according to claim 1, characterized in that at least one of the selection groups mentioned below is selected for the components A to F, preferably the selection groups for the components A, B and C or A, B, C and E are selected and especially preferably all selection groups are selected simultaneously:
A: the aliphatic diamines are selected from the group consisting of 1,6-hexanediamine, 1,8-octanediamine, 2-methyl-1,8-octanediamine, 1,9-nonanediamine, 1,10-decanediamine, 1,12-dodecanediamine, 1,3-diaminocyclohexane, 1,4-diaminocyclohexanediamine, isophorone diamine, 1,3-bis-(amino-methyl)cyclohexane, 1,4-bis-(aminomethyl)cyclohexane, preferably selected as 1,6-hexanediamine or 1,10-decanediamine;
B: the aromatic phosphorus-free dicarboxylic acids are selected from the group consisting of terephthalic acid, isophthalic acid and mixtures thereof;
C: the phosphorus-containing aromatic dicarboxylic acids are selected from the group consisting of 3,5-dicarboxyphenyldiphenylphosphine oxide, 3,5-dicarboxyphenyl-dimethylphosphine oxide, 3,5-dicarboxyphenyldiethylphosphine oxide, 2,4-dicarboxy-phenyldiphenylphosphine oxide, 2,4-dicarboxyphenyldimethylphosphine oxide, 2,4-dicarboxyphenyldiethylphosphine oxide, preferably selected from 3,5-dicarboxyphenyldiphenylphosphine oxide, 3,5-dicarboxyphenyl-dimethylphosphine oxide or 3,5-dicarboxyphenyldiethylphosphine oxide, more preferably selected from 3,5-dicarboxyphenyldiphenylphosphine oxide;
D: the diamines with aromatic structural units are selected from the group consisting of m-xylylenediamine, p-xylylenediamine and mixtures thereof;
E: the aliphatic dicarboxylic acids are selected from the group consisting of adipic acid, 1,10-decanedioic acid, 1,12-dodecanedioic acid, 1,14-tetradecanedioic acid, 1,16-hexadecanedioic acid, cyclohexane-1,3-dicarboxylic acid, cyclohexane-1,4-dicarboxylic acid and mixtures thereof;
F: α,ω-aminocarboxylic acids or the lactams F are selected from the group consisting of α,ω-aminoundecanoic acid, caprolactam and lauric lactam as well as mixtures thereof.

4. Polyamide according to claim 1, characterized in that the at least one further polyamide unit is selected from the group AB, AE and F, the content of the polyamide units AC being 1 to 99 mol %, preferably 10 to 90 mol %, especially preferably 10 to 60 mol % and wherein the sum of the contents of the polyamide units AB, AE and F is 1 to 99 mol %, preferably 10 to 90 mol %, especially preferably 40 to 90 mol %, in each case based on the sum of the polyamide units AB, AC, AE and F.

5. Polyamide according to claim 1, characterized in that the aromatic dicarboxylic acids B are selected from the group consisting of terephthalic acid or a mixture of terephthalic acid and isophthalic acid.

6. Polyamide according to claim 1, characterized in that
the polyamide units AB are selected from the group consisting of the polyamide units 6I, 6T, 8I, 8T, 9I, 9T, 10I, 10T, 12I, 12T, 6T/6I, 9T/9I, 10T/10I, 12T/12I, 6T/10T, 6T/9T, 6T/8T, BACI, BACT, BACT/BACI, BACT/6T, BACT/10T;
or
the polyamide units AB consist of
a1 60 to 100 parts by weight, preferably 55 to 85 parts by weight, particularly preferably 60 to 80 parts by weight of polyamide units AB which are derived from terephthalic acid in combination with hexamethylenediamine, 1,3-bis(aminomethyl)cyclohexane and/or 1,10-decanediamine;
a2 0 to 40 parts by weight, preferably 15 to 45 parts by weight, more preferably 20 to 40 parts by weight of polyamide units AB derived from isophthalic acid in combination with hexamethylenediamine, 1,3-bis(aminomethyl)cyclohexane or 1,10-decanediamine;
and wherein the parts by weight of components a1 and a2 together make up 100 parts by weight;
and/or
the polyamide units AE are selected from the group consisting of the polyamide units 66, 610, 611, 612, 614, 616, 618, 106, 1010, 1011, 1012, 1014, 1016, 1018, BAC6, BAC10, BAC11, BAC12, BAC14, BAC16.

7. Polyamide according to claim 1, characterized in that the polyamide X consists exclusively of the polyamide units AB, AC and AE, preferably consisting exclusively of the polyamide units AB and AC or AC and AE.

8. Polyamide according to claim 1, characterized in that
the polyamide X in the form of the pre-condensates has a solution viscosity ηrel, that is determined using a solution of 0.5 g of polymer granules in 100 ml of m-cresol at 20° C. in accordance with ISO 307:2007, in the range from 1.08 to 1.39, particularly preferably in the range from 1.10 to 1.35, especially in the range from 1.12 to 1.30;
and/or
the polyamide X in high molecular weight or post-condensed form has a solution viscosity ηrel, that is determined using a solution of 0.5 g of polymer granules in 100 ml of m-cresol at 20° C. according to ISO 307:2007, in the range from 1.40 to 2.50, particularly preferably in the range from 1.45 to 2.20, especially in the range from 1.50 to 2.00
and/or
the polyamide X has a flame protection classification V0, that is determined according to UL94 on test specimens of the dimensions 127×12.7×0.35 mm, 127×12.7×0.5 mm, 127×12.7×0.75 mm, 127×12.7×1.5 mm and 127×12.7×3.0 mm, which were previously conditioned for 48 h in a standard climate at 23° C. and a relative humidity of 50% or stored for 7 days at 70° C. in a convection oven.

9. Method for the production of a polyamide according to claim 1, characterized in that the method comprises a polycondensation reaction between
at least one aromatic dicarboxylic acid B and/or one aliphatic dicarboxylic acid E,
at least one phosphorus-containing aromatic dicarboxylic acid C according to formula 1 and/or formula 2, wherein the substituents R1, R2 are each independently C1-C8 alkyl or aryl and the substituents R3, R4, R5 are each independently H, alkyl, aryl, F, Cl, Br or P(R1)(R2)O;
and at least one aliphatic diamine A;
and as an option, further monomers D and F, possibly in the presence of mono-functional regulators G and/or process auxiliary materials.

10. A polyamide molding compound FM comprising the polyamide X according to claim 1, and at least one filler and/or at least one additive and/or at least one polyamide Y other than polyamide X.

11. Polyamide molding compound FM according to claim 10, characterized in that it contains or preferably consists of the following components:
25 to 99.99% by weight of polyamide X
0 to 70% by weight of at least one filler T;
0.01 to 50% by weight of at least one additive S other than X and T;
wherein the components S, T and X together make up 100% by weight.

12. Polyamide molding compound FM according to claim 10, characterized in that the polyamide molding compound FM contains or preferably consists of the following components:
25 to 100% by weight of a polymer mixture P containing or preferably comprising
20 to 80% by weight of polyamide X and
20 to 80% by weight of polyamide Y that is different from polyamide X, preferably selected from the group consisting of: polyamide 6, polyamide 66, polyamide 610, polyamide 612, polyamide 614, polyamide 616, polyamide 1010, polyamide 1012, polyamide 1014, polyamide 1016, polyamide 11, polyamide 12, polyamide 6/12, polyamide 6I, polyamide 9T, polyamide 10T, polyamide 6T/6I, polyamide 6T/66, polyamide 6T/10T or mixtures thereof,
wherein the sum of X and Y is 100% by weight of the polymer mixture P;
0 to 70% by weight of at least one filler T;
0 to 50% by weight of at least one additive S other than X, Y and T;
wherein the components P, S and T together make up 100% by weight.

13. A molded part of a polyamide X according to claim 1, or of a polyamide molding compound FM according to any one of claims 10 to 12, or comprising at least one region or coating of a polyamide X according to any one of claims 1 to 8, or of a polyamide molding compound according to any one of claims 10 to 12, preferably produced by injection molding, injection blow molding, injection compression molding, pultrusion, melt spinning, extrusion or blow molding.

14. Molded part according to claim 13, characterized in that the molded part is selected from the group consisting of fibers, films, profiles, tubes, containers, semi-finished products, finished parts or hollow parts, housings, housing parts, frames, protective housings, covers or cladding elements, especially for electrical appliances, electronic appliances, electro-optical appliances, electro-optical components, connectors, fans, especially fan wheels, office automation devices, consumer electronics, components for the automotive sector, especially selected from cylinder head covers, engine covers, housings for intercoolers, intercooler flaps, suction pipes, suction manifolds, connectors, gear wheels, fan wheels, intercoolers, headlamp housings, reflectors, adaptive headlight adjustment, gear wheels, plug connections, connectors, including those for gasoline, diesel, urea and compressed air lines, components for electric vehicles, profiles, films or layers of multilayer films, electronic components, housings for electronic components, tools, nozzles and fittings for connecting hoses or tubes, electrical or electronic component, a circuit board, a part of a circuit board, a housing component, a film, a line, especially in the form of a switch, a distributor, a relay, a resistor, a capacitor, a coil, a lamp, a diode, a LED, a transistor, a connector, a regulator, a memory and/or a sensor.

15. Use of a polyamide X according to claim 1, or of a polyamide molding compound FM according to any one of claims 10 to 12, for the production of molded parts according to claims 13 and 14, especially fibers, films, profiles, tubes, containers, semi-finished products, finished parts or hollow parts, and for coating molded parts.
